(19) United States
(12) Patent Application Publication
(10) Pub. No.: US 2006/0095403 A1
(43) Pub. Date: May 4, 2006

(54) Method, system and program product for filtering model objects

(75) Inventors: Xuan Zhang Chen, North York, Ontario (CA); Li Ding, North York, Ontario (CA); David K. McKnight, Newmarket, Ontario (CA); Kushal S. Munir, Toronto, Ontario (CA)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: INTERNATIONAL BUSINESS MACHINES CORPORATION, Armonk, NY (US)

(21) Appl. No.: 10/904,304

(22) Filed: Nov. 3, 2004

(51) Int. Cl. G06F 17/30

(52) U.S. Cl. 707/3

(57) ABSTRACT

The present invention generally combines the concepts of view filtering with query filtering to provide an improved object filtration mechanism. Under the present invention, input for an object and a filter string is received. It is then determined whether the filter string was used in a previous query. If not, a query filter is generated based on the filter string if the filter string was not used in a previous query. Thereafter, a query for the object is generated and performed while applying the query filter. When results of the query are received, a view filter (generated based on the filter string) is used to filter the results. After this additional filtering, a view of the results is generated.

### FIELD OF THE INVENTION

In general, the present invention relates to generic way to filter (model) objects. Specifically, the present invention combines query filtering techniques with view filtering techniques to provide enhanced object querying and/or viewing.

### RELATED ART

User interfaces provide a way to display information using various types of “logical” or “display” structures that are suitable to an application such that a user can view and manipulate it in a meaningful way. Tree, table, list and other structures are commonly used to display lists of information. To assist a user who selects such a structure for displaying information, filtering mechanisms can be applied that are used to reduce the amount of information displayed to that which the user is interested in viewing. In general, there are two primary ways that information can be filtered:

1. View Filtering: Once a set of information has been retrieved via a query, the results are displayed in a structure (e.g., tree, table, list, etc.) where one or more view filters has been defined. Of the query results, those objects of data that meet the criteria of each view filter are displayed, while the others are not. This mechanism can be seen at work in current user interfaces including the ECLIPSE Integrated Development Environment (IDE) framework, where it is the primary means of data reduction for display to the user.

2. Query Filtering: In contrast to view filtering, where all information is retrieved upfront before being filtered, query filtering occurs at a lower level. Specifically, a set of one or more query filters is defined and passed into a query. The infrastructure that does the query does it in such a way that only information that meets the filter criteria are retrieved. Once those results come back to the widget for display, there is no need to filter at the widget level, since the data reduction occurred during the query itself. This mechanism can be seen at work in many applications, more notably database management tools, where queries are made explicitly to retrieve only the desired information. In ECLIPSE, the Remote System Explorer (RSE) also uses such a mechanism to reduce data when querying information from remote hosts.

The advantage of view filtering is that, at the structure level, it can be applied generically and dynamically to any set of data that is to be displayed. Regardless of the type of information and how such information is retrieved, each piece of data is displayed the same way; hence it is able to apply the same filtering criteria to anything that could be displayed. The advantage of query filtering is that when, in situations where queries can take a long time, such as those cases where enormous amounts of information are returned, especially with network latency involved, information is reduced at its source, less time and bandwidth is wasted in bringing irrelevant results to the user interface.

It's common to provide filtering in a static way, such that filters are predefined or explicitly defined prior to displaying information in a structure. More advanced structures take this further to provide more dynamic filtering usage. For example, there are dialogs that provide an entry field so that a user may input a pattern representing the filter criteria/string to apply on a view. An example of this is the ECLIPSE “Open Type” dialog 10 shown in FIG. 1. As a user types characters into the input field 12, the list of matching types 14 gets updated to match the filter criteria 16 presented in the filter entry-field. Essentially, the view-filter is updated and the table structure for matching types gets “refreshed” based on the new view filter. When strictly a view filter is used to provide such a structure, all of the information needed to display results for “*” are required upfront. Since the set of all information is required in this case, if that set is very large, it may be very expensive to perform the initial query prior to object display. Under those performance-intensive conditions, use of such a structure is not always desirable.

Alternatively, when strictly a query filter is used to provide such a structure, there are different problems. Since no information exists up-front, each time a user alters the filter string, a new query needs to be made to retrieve the view results. Large queries can be expensive and since these would happen as frequently as the user types, the expense is compounded.

In view of the foregoing, there exists a need for a compromise to be made that inherits the benefits and solves the problems of each of these mechanisms. Specifically, a need exists for a system to provide both view filters and query filters in concert. Each filter references the same filter string, providing its own data reduction in its own way. To this extent, a need exists for a method, system and program product for filtering model objects.

### SUMMARY OF THE INVENTION

In general, the present invention combines both query filter and view filter concepts to provide an improved method, system and program product for filtering model objects. Specifically, rather than retrieving an entire set of information up-front, a query filter will be applied so that only necessary information needed for the current filter string/criteria is retrieved. Once that set of data is retrieved, a view filter based on the filter string is applied. If the view filter initially matches all the information retrieved, no further reduction of information occurs at that point. However, if a user later alters the filter string such that it is more specialized (and hence a subset or within of the original filter string), then a new view filter will be applied on the current set of data to reduce it accordingly (since all information necessary for that filter has already been retrieved). If, on the other hand, a user alters the filter string such that it is more general and not within the initial filter string from which the initial query was made, a new query filter would be created to match the “delta” of the new filter string compared to the initial filter string—after the results are retrieved for the delta query, both the initial query results and the new query results would be compared against the new view filter so that only matching objects from those sets are displayed. By combining the two types of filters in this way, any upfront query expense is reduced via the delta query filters, while the view filter provides the means of reducing any overlap of data that exists as a result of cached query results.

A first aspect of the present invention provides a computer-implemented method for filtering objects, comprising: receiving input for an object and a filter string; determining whether the filter string was used in a previous query, and generating a query filter based on the filter string if the filter string was not used in a previous query; generating a query for the object to be performed while applying the query filter, and receiving results of the query; generating a view filter based on the filter string, and filtering the results using the view filter; and generating a view of the results after the results have been filtered using the view filter.

A second aspect of the present invention provides a computerized system for filtering objects, comprising: a system for receiving input for an object and a filter string; a system for determining whether the filter string was used in a previous query; a system for generating a query filter based on the filter string if the filter string was not used in a previous query; a system for generating a query for the object to be performed while applying the query filter, and for receiving results of the query; a system for generating a view filter based on the filter string; a system for filtering the results using the view filter; and a system for generating a view of the results after the results have been filtered using the view filter.

A third aspect of the present invention provides a program product stored on a recordable medium for filtering objects, which when executed, comprises: program code for receiving input for an object and a filter string; program code for determining whether the filter string was used in a previous query; program code for generating a query filter based on the filter string if the filter string was not used in a previous query; program code for generating a query for the object to be performed while applying the query filter, and for receiving results of the query; program code for generating a view filter based on the filter string; program code for filtering the results using the view filter; and program code for generating a view of the results after the results have been filtered using the view filter.

A fourth aspect of the present invention provides computer software embodied in a propagated signal for filtering objects, the computer software comprising instructions to cause a computer system to perform the following functions: receive input for an object and a filter string; determine whether the filter string was used in a previous query, and generating a query filter based on the filter string if the filter string was not used in a previous query; generate a query for the object to be performed while applying the query filter, and receive results of the query; generate a view filter based on the filter string, and filtering the results using the view filter; and generate a view of the results after the results have been filtered using the view filter.

A fifth aspect of the present invention provides a method for deploying an application for filtering objects comprising: providing a computer infrastructure being operable to: receive input for an object and a filter string; determine whether the filter string was used in a previous query, and generating a query filter based on the filter string if the filter string was not used in a previous query; generate a query for the object to be performed while applying the query filter, and receive results of the query; generate a view filter based on the filter string, and filtering the results using the view filter; and generate a view of the results after the results have been filtered using the view filter.

Therefore, the present invention provides method, system and program product for filtering objects.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a prior art dialog.

FIG. 2 depicts a system for filtering objects according to the present invention.

FIG. 3 depicts a first illustrative dialog according to the present invention.

FIG. 4 depicts a second illustrative dialog according to the present invention.

FIG. 5 depicts a third illustrative dialog according to the present invention.

FIG. 6 depicts an illustrative property sheet according to the present invention.

FIG. 7 depicts an illustrative viewer incorporating a property adapter according to the present invention

FIG. 8 depicts method flow diagram according to the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE DRAWINGS

As indicated above, the present invention combines both query filter and view filter concepts to provide an improved method, system and program product for filtering model objects. Specifically, rather than retrieving an entire set of information up-front, a query filter will be applied so that only necessary information needed for the current filter string/criteria is retrieved. Once that set of data is retrieved, a view filter based on the filter string is applied. If the view filter initially matches all the information retrieved, no further reduction of information occurs at that point. However, if a user later alters the filter string such that it is more specialized (and hence a subset or within of the original filter string), then a new view filter will be applied on the current set of data to reduce it accordingly (since all information necessary for that filter has already been retrieved). If, on the other hand, a user alters the filter string such that it is more general and not within the initial filter string from which the initial query was made, a new query filter would be created to match the “delta” of the new filter string compared to the initial filter string—after the results are retrieved for the delta query, both the initial query results and the new query results would be compared against the new view filter so that only matching objects from those sets are displayed. By combining the two types of filters in this way, any upfront query expense is reduced via the delta query filters, while the view filter provides the means of reducing any overlap of data that exists as a result of cached query results.

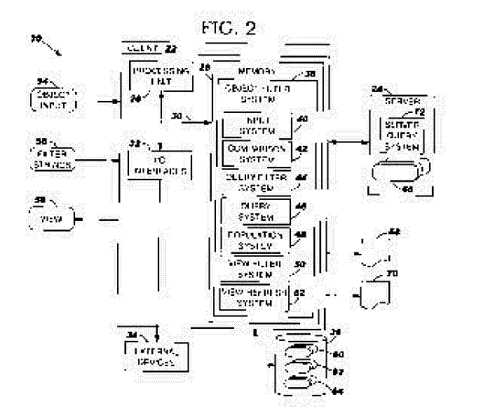

It should be understood in advance that as used herein, the term “model object” is intended to refer to any object that represents a piece of data. Referring now to FIG. 2, an illustrative system 20 for filtering model objects according to the present invention is shown. As depicted, system 20 includes a client 22 that communicates with a server 24 over a network such as the Internet, a local area network (LAN), a wide area network (WAN), a virtual private network (VPN), etc. Communication throughout the network could occur via a direct hardwired connection (e.g., serial port), or via an addressable connection that may utilize any combination of wireline and/or wireless transmission methods. Conventional network connectivity, such as Token Ring, Ethernet, WiFi or other conventional communications standards could be used. Still yet, connectivity could be provided by conventional IP-based protocol. In this instance, an Internet service provider could be used to establish interconnectivity. Regardless of the illustrative embodiment depicted in FIG. 2, it should be appreciated that the teachings of the present invention could be practiced in any type of environment. For example, the teachings recited herein could be implemented on a stand-alone computer system. To this extent, FIG. 2 depicts a client-server environment only as one possible embodiment of the present invention.

In any event, as shown, client 22 includes processing unit 26, memory 28, bus 30, input/output (I/O) interfaces 32, external devices/resources 34 and storage unit 36. Processing unit 26 may comprise a single processing unit, or be distributed across one or more processing units in one or more locations, e.g., on a client and server. Memory 28 may comprise any known type of data storage and/or transmission media, including magnetic media, optical media, random access memory (RAM), read-only memory (ROM), a data cache, a data object, etc. Moreover, similar to processing unit 26, memory 28 may reside at a single physical location, comprising one or more types of data storage, or be distributed across a plurality of physical systems in various forms.

I/O interfaces 32 may comprise any system for exchanging information to/from an external source. External devices/resources 34 may comprise any known type of external device, including speakers, a CRT, LED screen, hand-held device, keyboard, mouse, voice recognition system, speech output system, printer, monitor/display, facsimile, pager, etc. Bus 30 provides a communication link between each of the components in client 22 and likewise may comprise any known type of transmission link, including electrical, optical, wireless, etc.

Storage unit 36 can be any system (e.g., a database, etc.) capable of providing storage for information under the present invention. Such information could include, for example, view adapters 60, query adapters 62, property adapters 64, etc. As such, storage unit 36 could include one or more storage devices, such as a magnetic disk drive or an optical disk drive. In another embodiment, storage unit 36 includes data distributed across, for example, a local area network (LAN), wide area network (WAN) or a storage area network (SAN) (not shown). Although not shown, additional components, such as cache memory, communication systems, system software, etc., may be incorporated into client 22. Moreover, it should be understood that server 24 will include computerized components similar to client 22. Such components have not been depicted for illustrative purposes only.

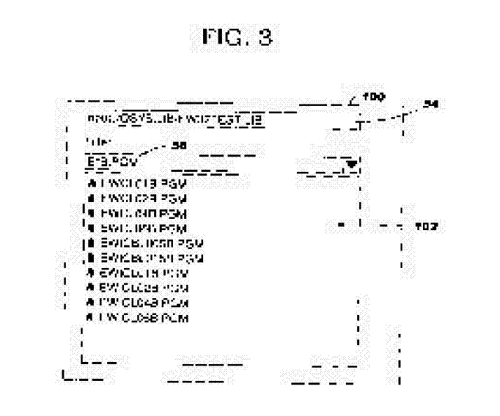

Shown in memory 28 of client 22 as a program product is object filter system 38, which includes input system 40, comparison system 42, query filter system 44, query system 46, population system 48, view filter system 50 and view refresh system 52. It should be appreciated that object filter system 38 could be incorporated within (e.g., as a plug-in) or work in conjunction with any other program such as an Integrated Development Environment (e.g., ECLIPSE). The precise workings of object filter system 38 and its sub-systems will be further described in conjunction with FIGS. 3-7. However, in general, object filter system 38 will filter and generate a corresponding view 58 of one or more desired model objects 66 based on object input 54 and filter strings 56 as provided by a user or the like (not shown). Under the present invention, each type of model object 66 is associated with a view adapter 60, a query adapter 62 and, optionally, property adapter 64. The precise roles view adapters 60, query adapters 62 and property adapters 64 play with respect to model objects 66 under the present invention will be further described below. However, in general, model objects 66 are adaptable and typically implement an interface to access its associated view adapter 60 and query adapter 62 (and property adapter 64 if utilized) for that object type. In ECLIPSE, the standard means of getting at an associated adapter is by implementing the “IAdaptable” interface. Specifically, it declares a method getAdapter(Class adapterType), that is to be implemented by model objects to return the appropriate adapter for the specified adapter type.

Each view adapter 60 provides an interface associated with any given model object type that declares methods for getting information about an object to display in a structure. Each view adapter 60 typically includes methods to return the display text and icon associated with a given object. For example, a view adapter 60 for a Java class would define methods for returning the name of a class and the icon used in displaying a class in a viewer. The viewer would call both these methods to display an object in a list, while a view filter would call the getText(Object modelObject) method to determine whether its filter criteria can be met. Each query adapter 62 provides an interface associated with any given model object type that declares methods for querying the object contents of a particular data object. This interface, query(Object modelObject, String filterString), is the generic means by which a widget can get the model data to display in a view. The query adapter 62 is to be associated with any given input to a view (i.e., the container of any results) displayed in view 58. In the case where all classes are to be retrieved, this object may be the root of the Java Model, itself. The associated query adapter 62 would define its own query( ) method such that it would use the appropriate JDT model methods to return a set of Java objects matching the specified filter string. A simpler example is the case where a folder is the input to the view 58. In that case, the query adapter 62 for a folder would implement the query( ) method so that only the child files and folders that match a given filter string are returned.

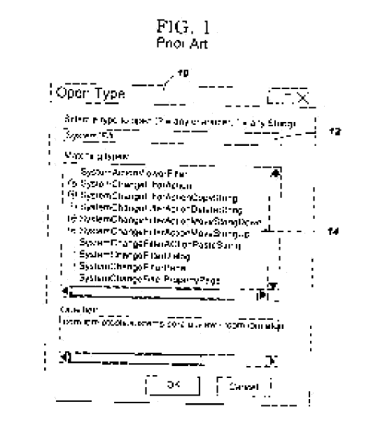

Referring now to FIG. 3, an illustrative example of the present invention will be explained. Specifically, FIG. 3 depicts a dialogue 100 into which a user can provide object input 54 and filter string/criteria 56. Assume in this example, that the user is attempting to obtain “iSeries” program objects 66 (FIG. 1) within a library. Further assume for the purposes of this illustrative example that FIG. 3 represents an initial attempt by the user to locate such objects. That is, assume for the example shown in FIG. 3, that no previous query was conducted by the user. As shown, object input 54 is “/QSYS.LIB/EW37TEST.LIB,” which is a model object that represents a particular iSeries library. As further shown, the initial filter string 56 that is to be applied is ““E*B.PGM.,” which indicates that the user wants to see only program objects inside the specified library that match that name.

Once this information is provided, it will be received by input system 40 (FIG. 2). It will then be passed to comparison system 42, which will determine whether a previous query was conducted using this or related information. In making this determination, comparison system 42 will examine Query Result Set (QRS) 68 and Query Result Set Filter List (QRSFL) 70 (FIG. 2). Since no previous query was conducted using this or related information, both QRS 68 and QRSFL 70 will be empty. Thus, query filter system 44 (FIG. 2) will generate a new query filter based on filter string 56. In this example, the query filter string will be the same as filter string 56 provided by the user. Once the query filter has been generated, query system 46 (FIG. 2) will generate a query for the requested program object that is performed by server 24 while applying the query filter. In generating the query, query system 46 will locate and utilize the query adapter 62 associated with the program object type identified by object input 54. The query and query filter will be received by server 24. Server query system 72 performs the query while applying the query filter to locate and return only the model objects (types) that met the query filter criteria. It should be appreciated that model objects 66 are shown locally on server for illustrative purposes only. To this extent, model objects 66 should be understood to reside in any location that is accessible by server 24 (e.g., another client, another storage unit, etc.).

As depicted in FIG. 3, the various matching (object) types 102 are depicted in dialogue 100 (e.g., by query system 46). By applying filter string 56 as a query filter, the volume of matches returned to client 22 can be efficiently controlled. In any event, population system 48 (FIG. 2) will populate QRS 68 with matching objects 102 and QRSFL with filter string 56 (and/or query filter, which in this case is identical to filter string 56). This will help control the need to do an additional query should the user later change filter string 56 as will be further discussed below. Before the matching types 102 are rendered in a view 58 (e.g., in a structure), filter string 56 will be re-applied thereto as a view filter. To this extent, view filter system 50 (FIG. 2) will generate a view filter based on filter string 56 (e.g., in this case it will be identical to filter string 56), and then apply the view filter to matching types 102. Thereafter, view refresh system 52 will generate view 58 (FIG. 2) of matching types 102 for the user. In generating the view, view filter system 50 will identify and utilize the view adapter 60 associated with each matching object 102 that is to be displayed in view 58 so that icons or names can be displayed. View 58 can be any type of structure such as a tree, a table, a list, etc. that can aid the user's viewing and/or manipulation of the matching types 102.

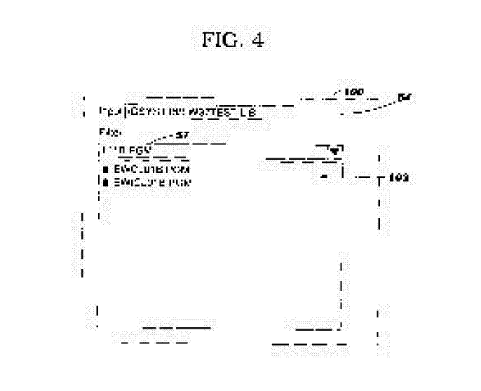

Referring now to FIG. 4, assume that the user changes filter string 57 to “E*1B.PGM.” The user has narrowed filter string 57, such that it is more specialized and still fits within the original filter string 56. In general, a filter string is considered to “fit within” a previous filter string if the filtering operation performed using the original filter string would encompass any results that would be yielded by filtering with the new filter string. As such, it should be understood that not all “narrowing” changes to a filter string will result in the new filter string fitting within the original filter string. For example, if the user had provided a new filter string of “G*1234A.PMG,” the new filter string could be considered narrower than the original filter string of E*B.PGM.” However, the two filters would yield entirely distinct results (i.e., there would be no encompassing). Similarly, if the user provides a new filter string that is broader than the original filter string, the results yielded by the new filter string would not by wholly encompassed within the result yielded by the original filter string. As such, a new filter string that is “broader” is not considered to “fit within” the original filter string under the present invention.

Regardless, the exemplary new filter string 57 shown in FIG. 4 fits within the original filter string 56 (FIG. 3). Upon receipt by input system 40 (FIG. 2), comparison system 42 will a examine QRS 68 and QSRFL 70 and determine that: (1) QRS 68 is not empty; (2) QRSFL 70 contains the (new) filter string 57 (e.g., filter string 57 fits within filter string 56); and (3) the original view filter contains the filter string 57. Based on this, comparison system 42 would determine that no new query is required. As such, query filter system 44 (FIG. 2) and query system 46 (FIG. 2) can remain dormant, while view filter system 50 generates a new view filter (based on filter string 57) that is applied to the previous results (e.g., matching types 102 of FIG. 2). The new set of matching types 103 are shown in dialogue 100. As can be seen, the results are substantially pared down from the results of FIG. 3. Because filter string 57 and matching types 103 were within (e.g., encompassed by) filter string 56 and matching types 102 (FIG. 2), population need not populate QRS 68 or QRSFL70 any further (although it could optionally do so).

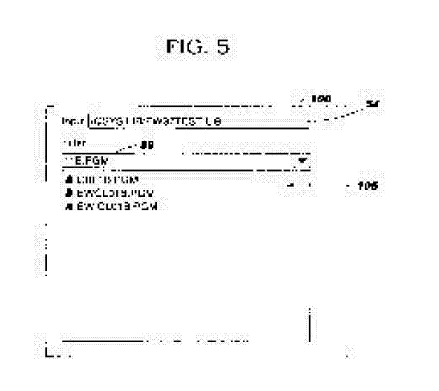

Turning to FIG. 5, the scenario where a new filter string 59 is provided that does not fit within the original filter string 56 (FIG. 3) is shown. As can be seen, filter string 59 is “*1B.PGM,” which is distinct from filter string 56. Specifically, the elimination of the “E” from the original filter string 56 broadened the possible universe of matches. Thus, matching types 105 can contain object types that were not present in matching object types 102 (FIG. 3). Under the present invention, when the information of FIG. 5 is received by input system 40 (FIG. 2), comparison system 42 (FIG. 2) will examine QRS 68 and QRSFL 70 and determine that: (1) QRS 68 is not empty; (2) QRSFL 70 does not contain the filter string 59 (e.g., filter string 59 does not fit within filter string 56); and (3) the original view filter does not contains the filter string 59. As such, comparison system 42 will determine that a new query is needed. In such a case, query filter system 44 (FIG. 2) will generate a new or “delta” query filter based on filter string 59 (and its differences from filter string 56). Query system 46 (FIG. 2) will then generate a new query and communicate the same to server 24. Server query system 72 will conduct the new query while applying the new query filter. As indicated above, query system 46 will utilize the query adapter 62 associated with the type of model object being sought.

The results of the query will be further filtered by a new view filter that is generated by view filter system 50 (FIG. 2) based on filter string 59. The result is matching types 105 shown in dialogue 100. In addition, population system 48 will populate QRS 68 and QRSFL 70 (FIG. 2) with matching objects 105 and filter string 59 for future comparisons. View refresh system 52 will then utilize the associated view adapter 60 to refresh view 58 for the user.

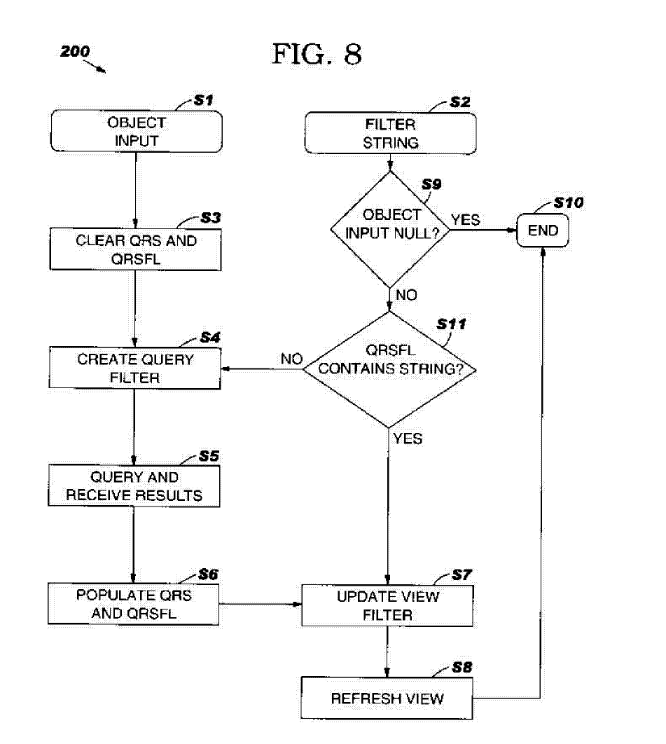

It should be understood that although not described in the illustrative example discussed above, it is possible for object input 54 (FIG. 1) to change independently of filter string 56. In such a case, QRS 68 and QRSFL 70 would both be cleared. Thereafter, query filter system 44 would generate a query filter and query system would generate a new query and communicate the same to server 24. When the results are received on client 22, they are further filtered by a view filter generated by view filter system 50. Just as with previous examples, QRS 68 and QRSFL 70 can be populated by population system 48, while view refresh system refreshes view 58 for the user. These concepts will be further illustrated in conjunction with FIG. 8.

As indicated above, property adapters 64 could be utilized in addition to view adapters 60 and query adapters 62 to enhance the filtering process. Under the present invention, each property adapter 64 provides an interface associated with any given model object type that declares methods for getting property information about a data object. A property adapter 64 typically includes methods to return the set of property descriptors associated with the object type along with methods to return the particular value for one such property on a specific data model object. For example, the following methods would likely be defined:

IPropertyDescriptor [ ] getPropertyDescriptors (Object modelObject)

String getPropertyValue (IPropertyDescriptor descriptor, Object modelObject)

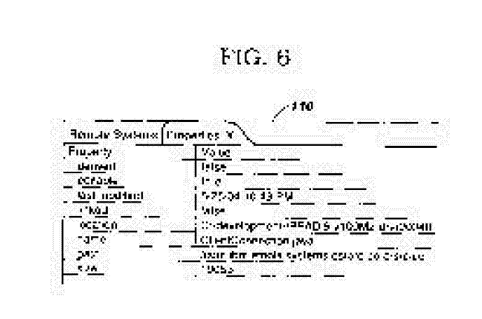

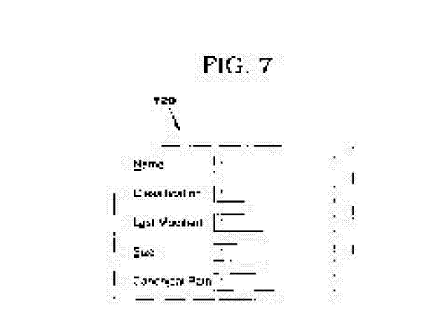

In the ECLIPSE IDE, property adapters (or IPropertySource implementations) are used by a property sheet viewer to display the list of properties for a given object along side its values. For example, referring to FIG. 6, a property sheet 110 is shown displaying the properties for a source file in Eclipse. It should be noted that a property adapter 64 (FIG. 2) is typically an extension of a view adapter 60 (FIG. 2) in that the properties that can be retrieved include the text (or name) value that a view adapter 60 returns. Using a property adapter 64, this viewer could be extended allow a user to specify filter strings for each property descriptor associated with an object, instead of just the name. In place of the single-filter string entry field, a set of fields that corresponds to the set of properties for a given object could be presented to the user. For example, if the object type to find comprises properties for “name,” “classification,” “last modified,” “size,” and “canonical path,” the set of filter fields 120 would be as depicted in FIG. 7.

Modifying any of the fields 120 would affect the view filtering and optionally the query filtering. For the view filtering to account for additional properties, the implementation of a view filter 60 would be altered as follows: (1) a view filter having of a set of filter strings (i.e. an array of strings) that map to the properties would be generated; (2) the view filter would be passed a property adapter for use in this more sophisticated way to do filtering; and (3) the view filter would compare each of the filter strings against each of the property values to determine whether or not a specific model object can be shown.

For the query filtering to account for additional properties, the implementation of the query adapter 64 would be altered as follows: (1) the query( ) API would need to allow specification of filters for properties. For example, the API could be changed to: query(String[ ] property, String[ ] propertyValueFilters).

Referring now to FIG. 8, an illustrative method flow diagram 200 according to the present invention is shown. Flow diagram 200 illustrates how object input and filter strings can change independently of one another. In steps S1 and S2, an object input and a filter string are received. Following the series of events that occurs upon reception of the object input independent from the filter string, in step S3, the QRS and QRSFL are cleared (the cleared contents can optionally be cached for future retrieval). In step S4, a query filter is created. As indicated above, the query filter can be a “delta” query filter that is based on the filter string received in step S2, and a previous filter string received. In step S5, the server will be queried and results will be received and, in step S6, the QRS and QRSFL will be populated. In step S7, the view filter will be updated based on the filter string and then applied to the query results. Then, in step S8, the view will be refreshed for the user.

With respect to the filter string received in step S2, in step S9, it will be determined whether the object input received in step S1 was null. If so, the process will terminate in step S10. However, if the object input was not null, it will be determined in step S11 whether the QRSFL contains the filter string. If not, the process will flow back through steps S4-S8 as discussed above. However, if the QRSFL contained the filter string, a new query need not be conducted. Rather, the view filter would be updated and applied in step S7 and the view refreshed in step S8 as discussed above.

It should be understood that although a particular sequence in which events occurred was described above, some of the events could have occurred in a different sequence. For example, view filter system 50 (FIG. 2) could have generated the view filter while query filter system 44 (FIG. 2) generated the query filter. As such, the order of some of the events discussed above should be understood to be variable. Moreover, a particular configuration of sub-systems is depicted within object filter system 38 for illustrative purposes only. To this extent, the functions thereof could be carried out by a different configuration.

It should also be appreciated that the present invention could be offered as a business method on a subscription or fee basis. For example, object filter system 38 could be created, supported, maintained and/or deployed by a service provider that offers the functions described herein for customers. That is, a service provider could offer to filter model objects for customers.

Still yet, it should be understood that the present invention could be realized in hardware, software, a propagated signal, or any combination thereof. Any kind of computer/server system(s)—or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product or a propagated signal, which comprises all the respective features enabling the implementation of the methods described herein, and which—when loaded in a computer system—is able to carry out these methods. Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

What is claimed is:

1. A computer-implemented method for filtering objects, comprising:
receiving input for an object and a filter string;
determining whether the filter string was used in a previous query, and generating a query filter based on the filter string if the filter string was not used in a previous query;
generating a query for the object to be performed while applying the query filter, and receiving results of the query;
generating a view filter based on the filter string, and filtering the results using the view filter; and
generating a view of the results after the results have been filtered using the view filter.

2. The method of claim 1, further comprising:
receiving an updated filter string;
comparing the updated filter string with the filter string; and
determining whether a new query is needed based on the comparing, wherein the new query is not needed if the updated filter string fits within the filter string.

3. The method of claim 2, further comprising:
generating a new delta query filter based on the updated filter string and the filter strings if the updated filter string does not fit within the filter string;
generating the new query to be performed while applying the new query filter, and receiving new results for the new query;
generating a new view filter based on the filter string, and filtering the new results using the new view filter; and
refreshing the view after the results have been filtered using the new view filter.

4. The method of claim 1, wherein the determining step comprises examining at least one of a Query Result Set (QRS) and a Query Result Set Filter List (QRSFL).

5. The method of claim 1, further comprising populating a Query Result Set (QRS) with the results and a Query Result Set Filter List (QRSFL) with the filter string.

6. The method of claim 1, wherein the querying step comprises utilizing a query adapter associated with the object for the query.

7. The method of claim 1, wherein the generating step comprises utilizing a view adapter associated with the object for the view.

8. A computerized system for filtering objects, comprising:
a system for receiving input for an object and a filter string;
a system for determining whether the filter string was used in a previous query; a system for generating a query filter based on the filter string if the filter string was not used in a previous query;
a system for generating a query for the object to be performed while applying the query filter, and for receiving results of the query;
a system for generating a view filter based on the filter string;
a system for filtering the results using the view filter; and
a system for generating a view of the results after the results have been filtered using the view filter.

9. The system of claim 8, wherein the system for receiving further receives an updated filter string, wherein the system for determining further compares the updated filter string with the filter string and determines whether a new query is needed based on the comparison, and wherein the new query is not needed if the updated filter string fits within the filter string.

10. The system of claim 9, wherein the system for generating the query filter further generates a new delta query filter based on the updated filter string and the filter string if the updated filter string does not fit within filter string, wherein the system for generating the query further generates the new query, wherein the system for generating the view filter further generates a new view filter based on the filter string, wherein the system for filtering further filters new results associated with the new query using the new view filter, and wherein the system for generating the view further refreshes the view after the new results have been filtered using the new view filter.

11. The system of claim 8, wherein the system for determining examines at least one of a Query Result Set (QRS) and a Query Result Set Filter List (QRSFL).

12. The system of claim 8, further comprising a system for populating a Query Result Set (QRS) with the results and a Query Result Set Filter List (QRSFL) with the filter string.

13. The system of claim 8, wherein the system for generating the query utilizes a query adapter associated with the object for the query.

14. The system of claim 8, wherein the system for generating the view utilizes a view adapter associated with the object for the view.

15. The system of claim 8, wherein the system for generating the query utilizes a property adapter associated with the object for the query.

16. A program product stored on a recordable medium for filtering objects, which when executed, comprises:
program code for receiving input for an object and a filter string;
program code for determining whether the filter string was used in a previous query;
program code for generating a query filter based on the filter string if the filter string was not used in a previous query;
program code for generating a query for the object to be performed while applying the query filter, and for receiving results of the query;
program code for generating a view filter based on the filter string;
program code for filtering the results using the view filter; and
program code for generating a view of the results after the results have been filtered using the view filter.

17. The program product of claim 16, wherein the program code for receiving further receives an updated filter string, wherein the program code for determining further compares the updated filter string with the filter string and determines whether a new query is needed based on the comparison, and wherein the new query is not needed if the updated filter string fits within the filter string.

18. The program product of claim 17, wherein the program code for generating the query filter further generates a new delta query filter based on the updated filter string and the filter string if the updated filter string does not fit within filter string, wherein the program code for generating the query further generates the new query, wherein the program code for generating the view filter further generates a new view filter based on the filter string, wherein the program code for filtering further filters new results associated with the new query using the new view filter, and wherein the program code for generating the view further refreshes the view after the new results have been filtered using the new view filter.

19. The program product of claim 16, wherein the program code for determining examines at least one of a Query Result Set (QRS) and a Query Result Set Filter List (QRSFL).

20. The program product of claim 16, further comprising program code for populating a Query Result Set (QRS) with the results and a Query Result Set Filter List (QRSFL) with the filter string.

21. The program product of claim 16, wherein the program code for generating the query utilizes a query adapter associated with the object for the query.

22. The program product of claim 16, wherein the program code for generating the view utilizes a view adapter associated with the object for the view.

23. The program product of claim 8, wherein the program code for generating the query utilizes a property adapter associated with the object for the query.

24. Computer software embodied in a propagated signal for filtering objects, the computer software comprising instructions to cause a computer system to perform the following functions:
receive input for an object and a filter string;
determine whether the filter string was used in a previous query, and generating a query filter based on the filter string if the filter string was not used in a previous query;
generate a query for the object to be performed while applying the query filter, and receive results of the query;
generate a view filter based on the filter string, and filtering the results using the view filter; and
generate a view of the results after the results have been filtered using the view filter.

25. The computer software of claim 24, wherein the instructions further cause the computer system to perform the following functions:
compare an updated filter string with the filter string; and
determine whether a new query is needed based on the comparing, wherein the new query is not needed if the updated filter string fits within the filter string.

26. The computer software of claim 25, wherein the instructions further cause the computer system to perform the following functions:
generate a new delta query filter based on the updated filter string and the filter strings if the updated filter string does not fit within the filter string;
generate the new query to be performed while applying the new query filter, and receiving new results for the new query;
generate a new view filter based on the filter string, and filtering the new results using the new view filter; and
refresh the view after the results have been filtered using the new view filter.

27. A method for deploying an application for filtering objects comprising:
providing a computer infrastructure being operable to:
receive input for an object and a filter string;
determine whether the filter string was used in a previous query, and generating a query filter based on the filter string if the filter string was not used in a previous query;
generate a query for the object to be performed while applying the query filter, and receive results of the query;
generate a view filter based on the filter string, and filtering the results using the view filter; and
generate a view of the results after the results have been filtered using the view filter.

28. The method of claim 27, wherein the computer infrastructure is further operable: compare an updated filter string with the filter string; and
determine whether a new query is needed based on the comparing, wherein the new query is not needed if the updated filter string fits within the filter string.

29. The method of claim 28, wherein the computer infrastructure is further operable to:
generate a new delta query filter based on the updated filter string and the filter strings if the updated filter string does not fit within the filter string;
generate the new query to be performed while applying the new query filter, and receiving new results for the new query;
generate a new view filter based on the filter string, and filtering the new results using the new view filter; and
refresh the view after the results have been filtered using the new view filter.
